(19) United States
(12) Patent Application Publication
(10) Pub. No.: US 2006/0047636 A1
(43) Pub. Date: Mar. 2, 2006

(54) Method and system for context-oriented association of unstructured content with the result of a structured database query

(76) Inventors: Mukesh K. Mohania, New Delhi (IN); Prasan Roy, New Delhi (IN)

Correspondence Address: Frederick W. Gibb, III;McGinn & Gibb, PLLC, Suite 304, 2568-A Riva Road, Annapolis, MD, 21401, US

(21) Appl. No.: 10/927,346

(22) Filed: Aug. 26, 2004

(51) Int. Cl. G06F 17/30

(52) U.S. Cl. 707/3

(57) ABSTRACT

A method, system, and program storage device for implementing the method of retrieving relevant unstructured data based on a result of a relational query on a structured database, wherein the method comprises retrieving a context from the structured database by the relational query; analyzing the retrieved context from the structured database; identifying an additional relevant term for a query on an unstructured database according to a result of the analyzing; and retrieving a desired data from the unstructured database according to a search with the additional relevant term.

### BACKGROUND OF THE INVENTION

1. Field of the Invention

The embodiments of the invention generally relate to database management, and more particularly to the integration of structured and unstructured data.

2. Description of the Related Art

With critical business information distributed across both structured and unstructured data sources, enterprises are increasingly realizing the importance of seamlessly integrating relevant structured and unstructured data. Conventional information integration solutions generally address this issue by providing a single point of access to both structured and unstructured data sources, enabling the application to submit a single query that spans these sources. This query is in a form that can be decomposed into independent sub-queries for the structured and unstructured data sources, and the result of the query is obtained by joining the results for these sub-queries. However, this “sum-of-parts” paradigm may not be powerful enough to enable seamless integration of related information since the onus of specifying an appropriate set of keywords needed to retrieve the relevant unstructured data (the context of the query) remains with the application, which is a limitation since the application (or the user) may not be aware of this context at the point of submitting the query.

More specifically, strictly typed data in an enterprise can be meaningfully decomposed at a fine granularity and stored in a relational database. Such data is mostly operational business data (e.g. sales, accounting, payroll, inventory, etc.), and has been the mainstay of database systems since their inception. However, this “structured” data constitutes only a part of the entire information content within an enterprise, which also includes “unstructured” content such as reports, email, meeting minutes, web-pages, etc. Due to its free-flow, untyped nature, this unstructured content is not as amenable to structured storage and retrieval in the (relational) database system as the strictly typed operational data. Thus, in a typical enterprise environment the structured data is managed by the database system and the unstructured data is managed by the content manager. This creates an artificial separation between the two data sources, which is unfortunate since they are complementary in terms of information content.

Effective knowledge management, however, requires seamless access to information in its totality, and enterprises are fast realizing the need to bridge this separation. This has led to significant research as well as commercial activity towards the integration of structured and unstructured data.

In other words, providing a single point of access to the data sources addresses only part of the overall information integration needs of an enterprise, since it remains the onus of the user to specify the context of the information needed (in terms of informative and discriminating keywords). In order to find these keywords, the user might have to sift through an enormous amount of data and manually evaluate all the terms therein for their informative and discriminative value. This is clearly a time-consuming and onerous task.

Furthermore, some conventional information integration solutions require that the user design a common schema, which is a task that needs considerable skill on the part of the user and can, at best, be semi automated. Even after the design, the maintenance of the schema in the face of changes in the schema of the underlying sources calls for continuous support from the user.

For example, assuming that an investment services company maintains an extensive amount of data; structured data (stock-market statistics, company portfolios, and transaction history, etc.) as well as unstructured data (analyst advisories, risk-assessment reports, memos, articles, news stories, etc.), the data available is vast and varied, and one of the challenges an analyst working for the company faces is how to effectively distill information relevant to his/her current needs from this data in order to gain insights on the current stock market activities.

For instance, suppose the analyst needs insights on why only certain pharmaceutical stocks A, B, and C have been performing much better than the others since a particular date, say for example, Feb. 1, 2004. At this point, the analyst knows little more than the names A, B, and C of the companies he/she needs to investigate. As a first step, he/she decides, perhaps based on some intuition, or as a random choice, to explore the patents held by each of these companies. Working on a system supporting state-of-the-art structured and unstructured information integration technology, he/she submits the query:
SELECT c.*, p.*
FROM Companies c, Patents p
WHERE c.name IN {‘A’, ‘B’, ‘C.’}
   AND c.id=p.companyid
OUTER UNION
SELECT a.*
FROM Articles a
WHERE text_search (a.text, ‘A B C’)
   AND a.date >=‘02/01/04’
      on the integrated database, and then sifts through the returned information looking for clues regarding what, if anything, is common between these companies. After much effort, he/she chances upon the fact that these companies hold patents on drugs that are used to cure a disease D. He/she then refines the search expression to text search (a.text, ‘A B C D’), which yields a recent advisory mentioning a possible future out-break of this particular disease. Relating this advisory with the companies' patents, the analyst now has the insight he/she was looking for.

Searching for related information across the structured and unstructured data sources in the above manner is clearly burdensome and time-consuming, requiring substantial skill, and luck, on the part of the analyst; luck because he/she chose to investigate the patents in the above example. Under different circumstances, these companies could have shared an institutional investor, something that would be apparent only after joining with the Investors table of the database instead. In that case, hypothetically, the analyst would use the name of the common investor as a search term to chance upon a memo stating that this investor has recently picked up large volumes of stocks in these particular companies. However, the analyst is relatively clueless a priori on whether to join Companies with Investors, or with Patents and so would likely join with both, thereby increasing the load of data she needs to sift through.

The example above illustrates a limitation of the conventional structured and unstructured information integration solutions proposed thus far: that the onus of specifying the appropriate set of keywords relating relevant unstructured data with the structured data in a query (hereafter termed the context of the query) remains with the application. This is a limitation since the end-user (or the application acting on her behalf) might not be able to identify these keywords at the point of submitting the query. In the example above, the additional keyword ‘D’ was part of the query context, but the analyst was not aware of this fact at the point of submitting the query.

There has been significant work in both the DB (database) and IR (information retrieval) communities towards integrating unstructured data (text) and structured data (relational data or object-oriented data) into a single physical system. In the past few years, there has been significant effort on the part of various vendors to provide full text search as an integral part of the database system. Some conventional approaches take the information extraction approach towards integration data and text through an OLAP-style (online analytical processing-style) interaction model. Other conventional approaches address joins between the structured data and text data in a loosely coupled system.

Furthermore, query expansion, as explored in IR research, involves starting from a set of keyword (the search query) and, by explicit or implicit relevance feedback, refining this set to be more expressive of the user's information needs. There is a slight relationship between query expansion and context computation proposed as a part of this invention, which starts with a possibly empty set of keywords, and based on the relevance “feedback”, adds keywords to this set.

However, the conventional approaches have generally not identified or addressed the context-oriented aspect of unstructured and structured data information integration. Therefore, their remains a need for a context-oriented association of unstructured and structured data information integration.

### SUMMARY OF THE INVENTION

In view of the foregoing, an embodiment of the invention provides a method of retrieving relevant unstructured data based on a result of a relational query on a structured database, and a program storage device readable by computer, tangibly embodying a program of instructions executable by the computer to perform a method of retrieving a relevant unstructured data based on a result of a relational query on a structured database, wherein the method comprises retrieving a context from the structured database by the relational query; analyzing the retrieved context from the structured database; identifying an additional relevant term for a query on an unstructured database according to a result of the analyzing; and retrieving a desired data from the unstructured database according to a search with the additional relevant term.

The step of analyzing further comprises assigning weights to the context from the structured database by the relational query; computing an overall weight for each term of the context; and selecting terms with high overall weights. The method further comprises characterizing the context of the relational query as a set of terms in a query result that the relational query is focused on and quantifying a query focus on the set of terms as a ratio of a rarity of a term in the structured database to a rarity of the term in the query result. The method further comprises identifying terms most relevant to the relational query from all terms contained in the query result and identifying terms from the unstructured database which are relevant to the relational query and excluded in the query result, wherein the step of identifying terms from the unstructured database comprises augmenting the relational query with additional joins.

In the step of augmenting, the additional joins allow a search of a relevant immediate area of the relational query in the structured database for additional relevant terms. Moreover, the method further comprises computing the context of the relational query, wherein the step of computing further comprises using available database statistics from the structured database; and eliminating multiple executions of the relational query in various stages of augmentation.

Another aspect of the invention provides a method of integrating relevant unstructured data based on a result of a relational query on a structured database, wherein the method comprises receiving a query; augmenting the query by identifying a set of relevant keywords as a query context based on metadata information supplied by the structured database; generating a query result based on the augmented query; sending the query context to a search engine; the search engine retrieving relevant documents of the query context from an unstructured database; and consolidating the relevant documents with the query result.

An additional embodiment of the invention provides a system for retrieving a relevant unstructured data based on a result of a relational query on a structured database, wherein the system comprises means for retrieving a context from the structured database by the relational query; means for analyzing the retrieved context from the structured database; means for identifying an additional relevant term for a query on an unstructured database according to a result of the analyzing; and means for retrieving a desired data from the unstructured database according to a search with the additional relevant term.

The system further comprises means for assigning weights to the context from the structured database by the relational query; means for computing an overall weight for each term of the context; and means for selecting terms with high overall weights. Additionally, the system further comprises means for characterizing the context of the relational query as a set of terms in a query result that the relational query is focused on; means for quantifying a query focus on the set of terms as a ratio of a rarity of a term in the structured database to a rarity of the term in the query result; means for identifying terms most relevant to the relational query from all terms contained in the query result; means for identifying terms from the unstructured database which are relevant to the relational query and excluded in the query result; means for augmenting the relational query with additional joins; means for searching a relevant immediate area of the relational query in the structured database for additional relevant terms; means for computing the context of the relational query; means for using available database statistics from the structured database; and means for eliminating multiple executions of the relational query in various stages of augmentation.

Another embodiment of the invention provides a system for integrating relevant unstructured data based on a result of a relational query on a structured database, wherein the system comprises a user interface and a data broker adapted to manage an integration of structured and unstructured data, wherein the data broker comprises a query handler adapted to receive a query from the user interface and to send a query result and relevant documents based on the query result to the user interface; and a context handler adapted to receive a query from the query handler and to send the query result and a query context to the query handler. The system further comprises a structured data management system adapted to receive an augmented query from the context handler; an unstructured content management system; and a search engine coupled to the unstructured content management system, wherein the search engine is adapted to receive the query context and directives from the query handler and to send relevant documents based on the query result to the query handler.

According to an aspect of the system, the query comprises a structured query language (SQL) query and the query handler is adapted to receive directives from the user interface, wherein the directives comprise any of conditions on document metadata and additional keywords for the query. Furthermore, the structured data management system is adapted to send metadata to the context handler. Moreover, the query context comprises terms that occur in greater proportion in the query result as compared to the structured data management system, wherein the query context comprises keywords.

Another aspect of the invention provides a system for integrating relevant unstructured data based on a result of a relational query on a structured database, wherein the system comprises means for receiving a query; means for augmenting the query by identifying a set of relevant keywords as a query context based on metadata information supplied by the structured database; means for generating a query result based on the augmented query; means for sending the query context to a search engine; means for the search engine to retrieve relevant documents of the query context from an unstructured database; and means for consolidating the relevant documents with the query result.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a schematic diagram of a system diagram according to an embodiment of the invention;

FIG. 2 is an example of the methodology of computing the context of a given query according to an embodiment of the invention;

FIG. 3 is a context computation illustration according to an embodiment of the invention;

FIG. 4 is a graphical illustration comparing the relative performance of the Brute-Force and Two-Phase implementation approaches according to an embodiment of the invention;

FIG. 5A is a flow diagram illustrating a preferred method of an embodiment of the invention;

FIG. 5B is a flow diagram illustrating a preferred method of another embodiment of the invention; and

FIG. 6 is a computer system diagram according to an embodiment of the invention.

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

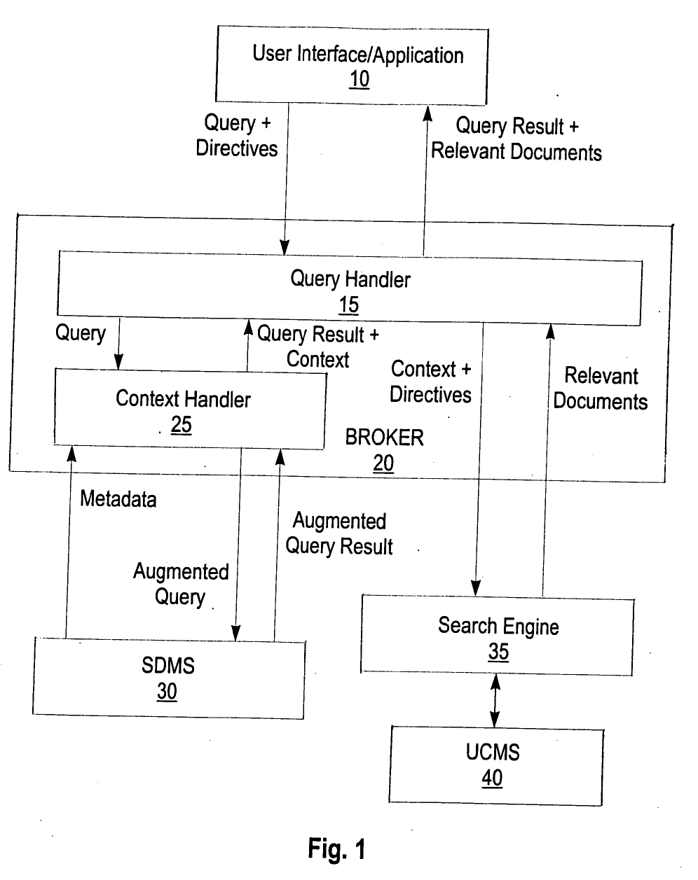

As mentioned, there remains a need for a context-oriented association of unstructured and structured data information integration. The invention addresses this need by automatically associating relevant unstructured data with the result of a relational structured query language (SQL) query on the structured data source. This involves (a) automatically computing the context of the SQL query, and (b) using this context to retrieve the unstructured data through a search engine. Accordingly, the embodiments of the invention provide techniques for computing the context of a SQL query. Referring now to the drawings, and more particularly to FIGS. 1 through 6 where similar reference characters denote corresponding features consistently throughout the figures, there are shown preferred embodiments of the invention.

Context-oriented integration of the structured and unstructured data as implemented by the embodiments of the invention and as illustrated in FIG. 1 is achieved through a Broker 20 that interfaces the systems managing the two kinds of data. This Broker 20 is coupled with a Structured Data Management System (SDMS) 30 on one side and an Unstructured Content Management System (UCMS) 40 on another side, and resides as a separate entity. The Broker 20 interfaces with SDMS 30 using JDBC® (JDBC® is a computer program used in accessing databases and is available from Sun Microsystems, Inc., Santa Clara, Calif., USA) and with UCMS 40 using a keyword-based search engine interface. The Broker 20 includes two components: (1) a Query Handler 15 and (2) a Context Handler 25.

The Broker 20 takes, as input from a user interface/application 10, a SQL query, optionally with additional directives (such as condition on document metadata, additional keywords, etc.). These constraints specify the restricted set of documents in the content repository to consider while searching for the relevant documents. In the example given earlier, the SQL query and the directive would be SELECT c.*FROM Companies c WHERE c.name IN {‘A’, ‘B’, ‘C.’} and date ‘02/01/04’ respectively. In these inputs, the analyst is only conveying what he/she already knows, unlike the inputs needed when working with current information integration technology (as previously explained in the earlier example) wherein the analyst had to decide upon the joins with the Patents and Investors tables. Conversely, the embodiments of the invention decide on such “augmentations” automatically, if needed).

On receiving these inputs, the Broker 20 functions in two broad steps. In the first step, the Query Handler 15 accepts the SQL query and the directives. The SQL query is passed to the Context Handler 25, where it is augmented with additional joins executed on SDMS 30, and is analyzed in order to identify a set of relevant keywords as the context. This is performed based on the metadata information (relational schema and statistics) supplied by SDMS 30. Thereafter, the query result, along with the context, is passed back to the Query Handler 15.

In the second step, the Query Handler 15 holds onto the query result, and passes the context along with the directives to the Search Engine 35, which retrieves relevant documents from UCMS 40 based on the context and orders them based on their relevance. This ordered list of documents is passed over to the Query Handler 15, which, in turn, consolidates it with the SQL query result and outputs the same to the user 10.

The challenge that exists in the above example is computing the context of the input query. That is, deriving the set of keywords that are most informative as well as relevant to the query. Simply including every keyword available in the query result would make little sense, since the resulting set is very likely to be a potpourri of unrelated terms. However, the embodiments of the invention provide techniques to pick relevant and informative keywords from the entire set of available terms, as is further described below.

The context of a SQL query includes the set of terms the query is focused on. That is, those terms that occur in greater proportion in the query result as compared to the underlying database. A first step involves finding the terms to be included in the query's context. Thus, the query's focus on a term is quantified. One way to do so is to measure the rarity of the term in the database as well as in the query result, and compare the two.

The rarity of a term in a table may be measured as follows. The embodiments of the invention make use of an IDF (Inverse Document Frequency), which is a metric well-known in the text information retrieval literature for measuring the rarity of a term in a collection of documents, and is computed as the log of the ratio of the total number of documents to the number of documents containing the term. Considering the rows in a table as documents, the IDF of a term t in a column A of a table X may be expressed as the log of the ratio of the number of rows in X to the number of rows in X containing the term t in column A.

However, there are two problems in this standard formulation. First, it does not consider the presence of NULLs in the column A. This is important because the embodiments of the invention interpret a NULL as missing information and, as a result, it is assumed (conservatively) that it could potentially take any non-NULL value if the data were clean. In particular, it could potentially be the term t. This suggests considering the rows containing NULL in addition to the rows containing t in column A while computing the IDF. Second, the IDF, as computed above, could be zero if all the rows contained t in the column A. Therefore, as discussed below, it is desirable that IDF>0. To ensure this, 1 is added to |X| in the expression. With these changes, the IDF equals:

$$IDF ( X , A , t ) = log ( \frac{1 + \vert X \vert}{\vert {σ}_{A = t} ( X ) \vert + \vert {σ}_{A = null} ( X ) \vert} )$$

where tεA, Aεcols(X), with tεA meaning |σ_{A=1}(X)|>0, and where X is evident from the context.

Based on the above, the focus of a query Q on a given term t in column Aεcols(Q) is thus quantified using the term weight function TW defined as:
TW(Q,A,t)=IDF(R(A),A,t)/IDF(Q,A,t))
where R(A) is the table in the database that the column A is derived from.

TW(Q,A,t) yields a way to compare the query's relative focus on the terms within a column. This allows one to define a measure of the query's relative focus on different columns in the result. Given two columns A,Bεcols(Q), it can be said that the query is more focused on column A than on column B if there exists a term t in A such that the query's focus on t is stronger than its focus on any term in B. The focus of a query Q on a given Aεcols(Q) can accordingly be quantified using a column weight function CW defined as:

$$CW ( A ) = {max}_{t ∈ A} TW ( Q , A , t )$$

The overall weight W of the term tεA, Aεcols(Q) is thus computed as:
W(Q,A,t)=CW(A).TW(Q,A,t)

According to an aspect of the invention, a methodology to compute the context of a query Q is thus to rank the terms in the query result on the basis of W(Q,A,t) and pick the top N terms, where N is a user-defined parameter. This methodology computes the context of a query from its result. Moreover, the methodology may be extended to look for the context beyond the given query by (a) looking at the projected out columns in the query, and (b) traversing foreign key relationship exploring the neighboring tables for related concepts.

Sometimes the columns that are projected out for convenience carry valuable information. The embodiments of the invention leverage this information by expanding the query to include these columns as well. That is, by removing the projection constraint. However, since the columns added as result columns are not part of the original query, they might not be as relevant as the columns that are part of the original query. If this is true, the weights of these columns should be scaled down. This decision is left to the user 10 (or the database administrator (DBA) (not shown)), and a tunable scaling parameter βε[0, 1] that scales down the weights of these columns from what they would have been if these columns formed part of the original query is defined therein.

A reasonable value for β can be determined by inspecting the schema. If there exists a table such that certain columns within the table are unrelated, then β is assigned a value near zero; if no such table exists, β is assigned a value near one; and when it is unsure whether a table exists, then β=0.5.

Normalization results in the distribution of related information across several tables, connected by foreign-key relationships. For example, in a bioclassification database with two tables: ‘Species’ with one row per distinct species and ‘Genus’ with one row per distinct genus, the information about the genre of a particular species in the Species table is encoded as a foreign key “pointing” to the corresponding row in the Genus table. The methodology provided by an embodiment of the invention can be extended in order to exploit these relationships among the tables.

There are two ways in which the foreign key relationships can be exploited. The first way, as illustrated above, is by following the foreign-key “pointers” in the forward direction. This transforms the sub-concepts to encompass super-concepts. For example, from species to their genus in the bioclassification database, from employees to their departments in a personnel database, from cities to states to countries in a geographical database, etc. The second way is by following the foreign keys in the backward direction. This results in a shift from super-concepts to all encompassed sub-concepts; from genus to all the species in that genus, from a department to all the employees in the department, from countries to all the states contained and, in turn, to all the cities contained therein.

While following the pointers in the backward direction may be useful at times, in most cases it leads to an unnecessary overload of information. For example, while seeking information about a department, the system will need to sift through all of the information about all of the employees in the department. Preferably, the embodiments of the invention exploit the foreign-key relationships in the forward direction only. However, backward relationships may also be practical.

With regard to the methodology provided by the embodiments of the invention, for each row in the query result, it is desirable to follow the foreign-key pointers and gather more terms beyond those present in the query result. In relational terms, this amounts to augmenting the query by adding a foreign-key join with the referenced table. With this perspective, following foreign keys in the forward direction also has the desirable effect that the extra information is just an appendage to the original query result, which remains untouched. In other words, the original query result can be extracted from the augmented query result by simply reintroducing the projection constraints; formally, if Q is the original query and AQ is the augmented query, then Q=π_{cols(Q)}(AQ).

Therefore, the methodology extends the input query (with projection constraints already removed) by augmenting with other tables in the database reachable through foreign-key relationships. To achieve this, two issues must be addressed. First, joining with all possible tables reachable through foreign-key relationships might be too expensive and unnecessary, thereby suggesting the need to select a subset. The subset of tables may be selected as follows: since it is desirable to limit the computation involved, a parameter M is defined as the maximum number of tables that can be augmented to the query. Ideally, it is desirable to select a subset of M tables on which the query has maximum focus. However, before this can be achieved, the focus of the query on a table should be quantified.

This may be quantified as follows: let Fεcols(Q) be a foreign-key column in the query, and let R be the table referenced by F. By definition, each term t in the column F references a single row in R. With that perspective, TW(Q,F,t), which is the quantification of the query's focus on the term t, may be interpreted as a quantification of the query's focus on the corresponding row in R as well. Extending this, CW(F), which is the quantification of the query's focus on the column F, may be interpreted as a quantification of the query's focus on the table R as well. An intuitive methodology to select the optimal subset of tables could thus be to find, by traversing the schema graph, all the tables reachable from the tables already present in the query by foreign-key relationships and pick the M tables with the maximum focus. However, this intuitive methodology is not necessarily feasible; not only because it involves exponential-time in the number of tables, but also because CW(F) is computed only for Fεcols(Q) and so it is known what the query's focus on the tables directly referenced by the query is, but not on the tables referenced in turn by the foreign-keys in these tables.

Conversely, the embodiments of the invention provide a non-intuitive approach, wherein the inventive methodology iteratively builds up the set of tables to augment with. The methodology maintains the set of S candidate foreign key columns in the query as augmented thus far (referred to as the augmented query AQ); since S⊂cols(AQ), it is known what CW(F) is for each FεS. Thus, in each iteration the methodology picks FεS with the maximum CW(F) and augments AQ with the table referenced by F. As it does so, it computes the weights of the columns added as a result and replaces F in S by the set of foreign-keys present in these columns.

Next, with regard to assigning weights to the columns added to the query result as a result of this augmentation, since the newly added columns are not a part of the original query, their weight should be scaled down from what they would be had they been part of the original query. However, a uniform scaling as proposed in that section is not appropriate in this case, wherein the scaling of the column added due to an augmentation should depend upon the weight of the foreign key column used to augment with the table.

As such, the embodiments of the invention extend the column weight function to the column A, added as a result of augmenting the query through the foreign-key F, as follows:

$$CW ( A ) = \frac{α CW ( F ) {CW}_{0} ( A )}{CW ( F ) + {CW}_{0} ( A )}$$

where CW₀(A) is the weight of column A had it been part of the original query (i.e. CW₀(A)=max_{tεA}TW(Q,A,t)) and αε[0,1] is a tunable parameter.

This weight assignment has certain desirable properties. First, it actually scales down the weight for each newly added column CW(A)<CW₀(A). Second, the assigned weights are consistent with CW₀(A) for any two newly added columns A₁,A₂ in the same table, CW(A₁)<CW(A₂) if and only if CW₀(A₁)<CW₀(A₂). Third, the assigned weights are consistent with CW(F). For example, assuming two columns A₁,A₂ such that CW₀(A₂)=CW₀(A₂), and supposing A₁ is added due to augmentation through the foreign key F₁, and A₂ is added due to augmentation through the foreign key F₂, then CW(A₁)<CW(A₂) if and only if CW(F₁)<CW(F₂). Fourth, the weight of the foreign key columns attenuates with the number of intermediate augmentations between the query and the underlying relation. In other words, if F_{1 and F}₂ are two foreign-keys such that F₂ is added due to augmentation through F₁, then CW(F₂)<CW(F₁).

Furthermore, the primary-key columns of the augmented tables are never included in the augmented query. This is because with contents identical to the corresponding foreign key column in the augmented query result (the foreign-key to primary key join is an equijoin) this column does not yield any new information.

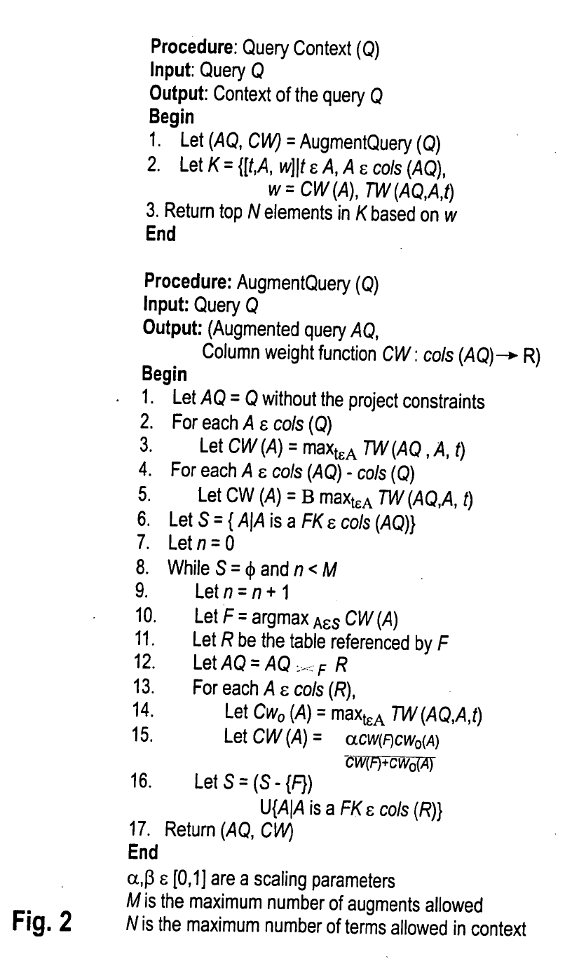

FIG. 2 illustrates a methodology of computing the context of a given query according to an embodiment of the invention, which indicates that the top level procedure QueryContext takes as input the query Q. It first invokes the procedure AugmentQuery with Q as the input. AugmentQuery, further discussed below, augments the query and also computes the weights CW of the columns in the augmented query AQ (line 1 of the protocol of FIG. 2). The terms in AQ's result are then ranked according to the overall weight (W), computed as the product of their term weights (TW) and the column weights (CW), and the top N terms, along with the corresponding column names and their overall weights, are returned as the context of the query Q (lines 2-3).

Next, the procedure AugmentQuery takes the query Q as the input and automatically augments it. It returns the augmented query A Q as well as the column weight function CW that assigns a real weight to each column in AQ. The first step is to remove the projection constraints in Q (line 1). Next, CW is computed for columns in Q (lines 2-3) as well as for the additional columns added (lines 4-5). The procedure next enters a loop, wherein for each iteration (lines 8-16) it chooses the most “promising” foreign key among the candidates, joins with the referenced table (lines 10-12), and computes CW for the columns added to AQ as a result (lines 13-15). The loop exits when no more candidate foreign keys exist, or when M augmentations have already been performed. The final augmented query A Q and the computed function CW are returned on exit (line 16).

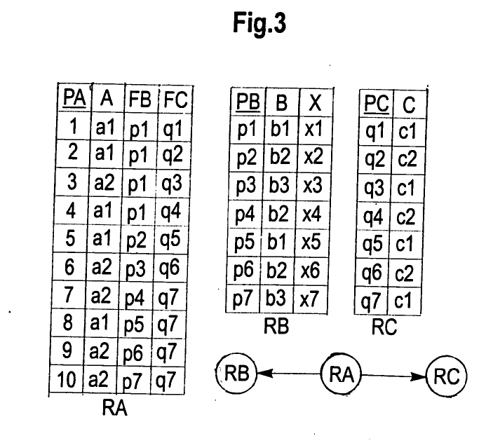

For example, a database may comprise three tables RA(PA,A,FB,FC), RB(PB,B,X) and RC (PC,C), as shown in FIG. 3. FA and FB are foreign keys to RB and RC respectively. Suppose the input query Q is: π_{A}(σ_{PA<=5}(RA)) (equivalently, in SQL: SELECT A FROM RA WHERE PA<=5).

The result of Q only includes the column A containing the terms α1 and α2. The execution of the procedure AugmentQuery with α=1.0, β=0.5, M=1, and N=4 may be traced as described below. AugmentQuery relaxes Q's project constraints to get AQ=σ_{PA<=5} (RA). In the result of this relaxed query AQ (the first five rows of RA), the column PA contains the terms 1, 2, . . . , 5, the column A contains the terms α1 and α2, the column FB contains the terms p1 and p2, and the column FC contains the terms q1, q2, . . . , q5. Computations yield:
TW(AQ,PA,t)=1.34 for t=1, 2, . . . , 5
TW(AQ,A,a1)=1.94, TW(AQ,A,a2)=0.44
TW(AQ,FB,p1)=2.49, TW(AQ,FB,p2)=1.34
TW(AQ,FC,t)=1.34 for t=q1,q2, . . . , q5.

The newly added columns are PA, FB and FC and the procedure computes, based on the available TW values, CW(PA)=0.5*1.34=0.67, CW(A)=1.94, CW(FB)=0.5*2.49=1.25 and CW(FC)=0.5*1.34=0.67. Since CW(FB)>CW(FC), FB is chosen and Q is augmented with RB, resulting in AQ=σ_{PA<=5}(RA) [symbol] _{FB=PB}RB. As a result of this augmentation, columns B and X are added to the query result. The primary key column PB is ignored because it does not yield any new information. Moreover, because only the first two rows of RB join, only the terms b1 and b2 for column B and x1 and x2 for column X are present in the query result. The TW values for these terms are computed as:
TW(AQ,B,b1)=3.42, TW(AQ,B,b2)=0.54
TW(AQ,X,x1)=5.12, TW(AQ,X,x2)=1.16
This results in CW(B)=1.25*3.42/(1.25+3.42)=0.92 and CW(X)=1.25*5.12/(1.25+5.12)=1.00.

Since M=1, only one augmentation is allowed and AugmentQuery exits with the final augmented query as AQ=σ_{PA<=5}(RA) [symbol] _{FB=PB}RB and the function CW on the columns of AQ as described above. The procedure then computes the overall weight for each term in AQ's result and assigns them their overall weights as the product of their TW value and their column's CW value. Since N=4, only the three terms with the highest overall weights are included in the context. Next, computations yield: W(AQ,A,a1)=CW(A)*TW(AQ,A,a1)=1.94*1.94=3.76, and similarly W(AQ,FB,p1)=1.25*2.49=3.11, W(AQ,B,b1)=0.92*3.42=3.15 and W(AQ,X,x1)=1.00*5.12=5.12. It can be verified, by further computing the weights for a2, p2, b2 and x2, that a1, p1, b1 and x1 are indeed the top four terms. The context computed for the query Q=π_{A}(σ_{PA<=5}(RA)) is thus:
{[p1,FB,3.11], [b1,B,3.15], [a1,A,3.76], [x1,X,5.12]}.

The embodiments of the invention may be implemented by several approaches. Three alternative implementation approaches are discussed herein. The first two approaches are relatively straightforward. The third approach is a hybrid, engineered by combining the positive points of the first two in a way that results in better performance and accuracy.

The first implementation approach is the Brute-Force Approach, which involves a straightforward implementation of the methodology shown in FIG. 2. However, there may be some inefficiency in this approach due to the interplay between the term weight computations and the query augmentations in the methodology. Again, in every iteration, in order to decide which foreign-key column to follow, the methodology utilizes the column weights CW(F) of the foreign-key columns FεS at that point. To compute the CW(F) for the column F, in turn, it is necessary to know all of the terms tεF and their distribution in the query result, so that TW(Q,F,t) may be computed.

The Brute-Force approach solves this problem by actually executing the augmented query thus far (or the increment over the prior iteration) before each iteration. This may be rather time-consuming, but it leads to an accurate context with respect to the methodology shown in FIG. 2.

The second approach is a Histogram-Based approach. Here, the database system maintains statistics for use by the query optimizer. In most commercial database systems, these statistics include the one-dimensional value histograms for each column across all the tables as well as the number of rows in the respective tables. The Histogram-Based approach uses these histograms to estimate IDF(R(A),A,t) for each tεA, Aεcols(Q). Further, these histograms are also used to estimate the (one-dimensional) value histograms for each column in the query result, which are then used to estimate IDF(Q,A,t). Together, these estimates are used to compute TW(Q,A,t)=IDF(R(A),A,t)/IDF(Q,A,t) for each tεA, Aεcols(Q).

However, in most conventional commercial systems, the histograms of the query result are estimated from the histograms on the base tables by assuming pair wise independence among the columns. This means, for example, that a value-based selection on one column has no effect on the relative distribution of the values in other columns. This leads to significant error in estimation, which may, in turn, lead to erroneous and misleading TW values if implemented by the embodiments of the invention.

Nevertheless, the implementation does not have to depend on the statistics maintained by the database system because the embodiments of the invention provide access to the entire data, and therefore can, in a preprocessing step, build histograms for its local use. After all, the augmentations are primary-foreign joins, and thus, in order to estimate the distribution of a column added as a result, the embodiments of the invention only need the two-dimensional histograms for the column against the table's primary key. Nonetheless, since for each of the two-dimensional histograms maintained, one of the dimensions is a primary key, the histograms will, at best, replicate the entire database unless, of course, multiple primary key values are bucketed together.

Bucketing of primary key values may lead to a crucial loss in information, as it is not known how to discriminate one value from the other in the same bucket. For example, suppose there is a table R(P,T) with P as the primary key. The embodiments of the invention, as suggested above, would maintain a two-dimensional histogram for (P,T) with multiple values in P bucketed together. Let [p1, t1] and [p2, t2] be two rows in R such that p1 and p2 are bucketed together in this histogram and t1 and t2 appear in no other rows in the table. Additionally, suppose there is an augmented query that includes a foreign-key column F that refers to P. The column F in the augmented query, however, has several occurrences of p1 but none of p2. Clearly, the column T in the query that results after augmenting with R (on F=P) should then have several occurrences of t1 but none of t2. Nevertheless, the histogram for the columns T in the query, estimated by multiplying the histogram for F with the two dimensional histogram (P,T) mentioned above, would have equal number of occurrences of both t1 and t2. As a result, TW(Q,T,t2) could have a high value and can actually be present in the context, which may be misleading. Thus while the Histogram-Based approach is likely to be very efficient, this efficiency is gained at a significant loss in accuracy, a rather undesirable consequence.

The third approach is a Two-Phase approach, which is the preferred approach. An approach to the context computation of a query is called safe if and only if all of the terms in the computed context are relevant. An approach that is not safe is called unsafe. Among the first two approaches, the Brute-Force approach, by design of the underlying methodology, is safe. On the other hand, the Histogram-Based approach, as has been shown already, may be unsafe.

The third approach is safe (the computed context contains only relevant terms, though not necessarily the most relevant terms) and has reasonable overheads. Accordingly, such an approach is more desirable than an expensive safe approach (the Brute-Force approach) or an inexpensive unsafe approach (the Histogram-Based approach). First, assuming two observations about the context computation methodology in FIG. 2: (1) the errors in context computation can occur at two points: (a) in finding the optimal augmentation for the input query, and (b) in computing the term weights TW for the terms in the query result; and (2) only the error due to (b) above can lead to unsafe behavior.

Based on these observations/assumptions, the Two-Phase approach is designed as a hybrid of the Brute-Force and Histogram-Based approaches. The Two-Phase approach augments the query based on estimated term and column weights (the “augmentation phase”), but corrects these weights by actually executing the augmented query and analyzing the result and uses these corrected weights to compute the final context (the “correction phase”).

Accordingly, the Two-Phase approach is safe. In terms of accuracy relative to the Brute-Force approach, the context computed by the Two-Phase approach differs from the context computed by the Brute-Force approach only if the two approaches find different augmentations. Terms present in the result of the common core (the input query with the projection constraints removed; this part of the query exists before augmentation), in particular, are analyzed similarly in both approaches.

The total overhead of the Two-Phase approach can be estimated and computed as (a) the overhead of the augmentation phase plus (b) the overhead of the correction phase beyond the cost of executing the original query, since the result for the original query can be obtained from the result of the augmented query by a trivial projection. The augmentation phase, as in the Histogram-Based approach, uses fast in-memory histogram computations. As such, its overheads are negligible. The augmented query, on the other hand, has execution overheads due to (i) removal of projection constraints, and (ii) inclusion of augmenting joins. The overheads due to (i) are expected to be negligible since the entire row for a table is usually kept together in the database system. The overheads due to (ii), while not expected to be negligible, are not expected to be substantial either because all of the augmenting joins are foreign-key to primary-key joins since each table is, by default, indexed on its primary-key. Therefore, these joins can be evaluated in a pipelined right-deep tree, which is rather efficient. Therefore, the Two-Phase approach is safe and involves reasonable computational overheads.

The embodiments of the invention were experimentally verified using part of an open directory for music related information as a dataset. The relational schema comprises five tables: BAND(bandid, name, country, year, foundedas) comprising information on various music bands; MEMBER(memberid, name, role, fbandid references BAND(bandid))6 comprising information about members of the bands in the BAND table; STYLE(styleid, style, fbandid references BAND(bandid)) comprising information about the music styles followed by the bands; RECORDS(recordid, recordType, title, relDate, format, studioOrLive, label, catalogno, fstyleid references STYLE(styleid)) comprising information about the records in a given music style coming from a given band; and finally TRACKS(trackid, discid, trackno, title, frecordid references RECORDS(recordid), fmemberid references MEMBER(memberid)) comprising information approximately the various tracks in a record, including a reference to the lead member associated with the track. The dataset comprises approximately 3,000 rows in the BAND table, approximately 4,000 rows in the MEMBERS table, approximately 2,500 rows in the STYLE table, approximately 2,400 rows in the RECORDS table, and approximately 26,000 rows in the TRACKS table.

The query set includes 25 queries Q₁ . . . , Q₂₅ where Qᵢ≡(SELECT TRACKS.title from TRACKS WHERE TRACKS.trackid<=i*1000). Since the values for TRACKS.trackid start at 1 and run in sequence, the result of the query Qᵢ comprises exactly i*1000 rows.

Finally, the embodiments of the invention were configured with the maximum number of augments M=4, the size of the context N=10, and the scaling parameters α=1.0 and β=0.95. Each query Q₁, . . . , Q₂₅ was run without the methodology provided by embodiments of the invention, with the methodology provided by embodiments of the invention implemented using the Brute-Force approach, and with methodology provided by embodiments of the invention implemented using the Two-Phase approach. The results are as follows: In terms of accuracy, it was discovered that the context returned by the respective approaches (Brute-Force and Two-Phase approaches) agreed in approximately 8 to 10 terms with a result size of 5,000 rows, and both of these approaches outperformed the conventional approach of not using the methodology provided by the invention. Thereafter, the two contexts diverged, but maintained an agreement in the top three terms throughout. To evaluate the relative performance of the two approaches, the following measurements were taken for each query:
SDMS Query Execution Time: The execution time of the query on SDMS 30. This is the cost without any inventive-related overheads.
Query Execution Time (Brute-Force approach): The time taken by the Brute-Force approach in executing queries on SDMS 30 across all of the iterations. Again, the query augmented is executed before each iteration in order to meet the statistics requirements for the iteration.
Total Time (Brute-Force approach): The total time taken by the Brute-Force approach. This includes the overheads due to the processing involved to select the terms to be included in the context from all the candidates.
Query Execution Time (Two-Phase approach): The time taken by the Two-Phase approach in executing queries on SDMS 30. Again, the only query executed is the final augmented query; the input query need not be executed separately since its result extracted from the result of the augmented query through a simple projection.
Total Time (Two-Phase approach): The total time taken by the Two-Phase approach. This includes the overheads due to the processing (histogram multiplication) involved in computing the histograms for the newly added foreign-key columns in each iteration, as well as the processing involved to select the terms to be included in the context from all the candidates.

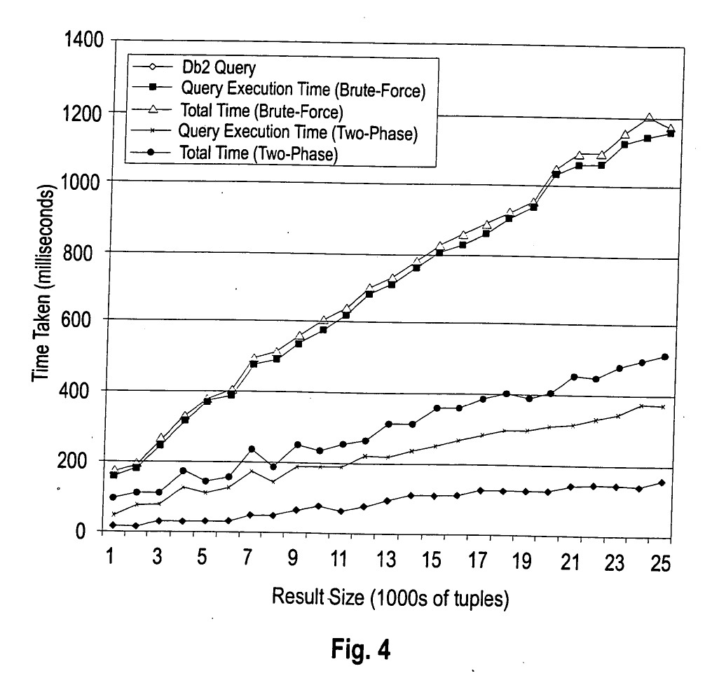

The results are plotted in FIG. 4. The close distance between the two curves for the Brute-Force approach in FIG. 4 implies that the Brute-Force approach spends almost all its time in executing queries. The high slope of these curves shows that the Brute-Force approach is not scalable. The Two-Phase approach, on the other hand, analyzes a large 25,000 row result in only approximately 500 ms.

Next, the Query Execution Time curve for the Two-Phase approach is compared with the SDMS Query Execution Time curve in order to verify that the augmentation joins introduced by methodology provided by embodiments of the invention, being only foreign-key to primary-key joins, are unlikely to incur a substantial overhead. It is important to realize that in order to get a general idea of this overhead, the distance between the curves should be interpreted in absolute, rather than relative terms. This is because even if the query Qᵢ had been an expensive one with a join of several tables, but with the same number (≈i*1000) of rows in its result (instead of the simple, efficient primary key select we chose for simplicity), the overhead due to the extra augmentation joins would have been the same. With that in mind, it can be seen that the overhead, less than 50 ms for a query result set of approximately 3,000 rows, and less than 100 ms for a query result size of up to 7,000 rows, seems rather reasonable.

Finally, looking for clues towards how to improve the performance for the Two-Phase approach further, there is a noticeable distance between the two curves for the Two-Phase approach implying that SDMS query execution is not a bottleneck in this approach, whereby the histogram multiplications occurring in each iteration are a sizeable fraction of the total cost. This calls for decreasing the number of buckets kept per histogram, since this will lower the complexity of the histogram multiplications.

The Total Time plotted in FIG. 4 for both the approaches does not include the time spent in computing the histograms for the columns of the query results. The reason is that this computation is redundant, wherein the database query optimizer computes the histograms of the intermediate results of the query since it needs them for cost analysis as it searches for the best plan for the query, and the histograms for the final result are computed as a by-product in the process.

In the techniques provided by the embodiments of the invention, the context derived is specific to a particular user query. However, the user usually has a session for a given context, issuing a set of related queries at a time. In such a scenario, accuracy can be improved significantly by considering the previous queries issued by the user in the same session as well while computing the context of the current query.

A possible way of aggregating context from prior queries could be to maintain a cache of terms, each term weighed by its relevance to the current user session. As a new query is issued, it is analyzed and the resulting context is used to update this cache. New terms get added and the weights changed appropriately in a manner very similar to traditional cache maintenance. The state of a cache at any point gives the current context of the user session.

For example, in a query on a patient database asking for the weight of patients suffering from a particular disease, it would be useful if the context includes a keyword (such as overweight, normal or underweight) characterizing the retrieved data. Handling columns containing non-categorical numeric data, such as weight (in the example above), salary, age, etc., is a problem because of the large domain. A possible conventional solution involves discretizing the domain into labeled buckets, and using the bucket labels instead of the actual data in context analysis. While useful, this conventional solution has several drawbacks, such as (a) inappropriate bucket boundaries may separate two values that are actually close to each other, and (b) values in different buckets are treated as completely dissimilar.

Conversely, the solution provided by the embodiments of the invention makes use of a reference table TA for the domain of the given column, for example, column A. This table associates each characterizing term t (such as overweight) with a typical numeric value n(t) (for example, 200 lbs) in the domain of A. The IDF(X,A,t) can then be computed as:

$$IDF ( X , A , t ) = log ( \frac{1 + \vert X \vert}{{\sum }_{u ∈ A} {ⅇ}^{- \frac{1}{2} {( \frac{u - n ( t )}{h} )}^{2}} + \vert {σ}_{A = null ( X )} \vert} )$$

where h is a bandwidth parameter.

Another implementation provided by the embodiments of the invention involves addressing context-based information integration in an XML-enabled environment. That is, extending XPath/XQuery based XML data retrieval by associating additional related XML fragments with the query result. This operation can be thought of as a “similarity join” of the result set with the underlying data, where the similarity is not based on a specific field (as handled by XQuery), but is instead based on the entire result set.

According to the embodiments of the invention, supporting this functionality involves (a) incorporating XPath/XQuery based data retrieval, (b) inferencing the query context from the XML fragments forming XPath/XQuery results, and (c) retrieving additional related XML fragments based on this context.

Generally, the embodiments of the invention provide a context-oriented approach to integrate structured and unstructured data. The embodiments of the invention formalize the context-oriented integration concept and provide a methodology to compute the context of a SQL query. Context-oriented information integration addresses an important gap between the queries handled by current information integration solutions and the actual needs of a business environment. As such, context-oriented information integration is an important next step for structured and unstructured information integration.

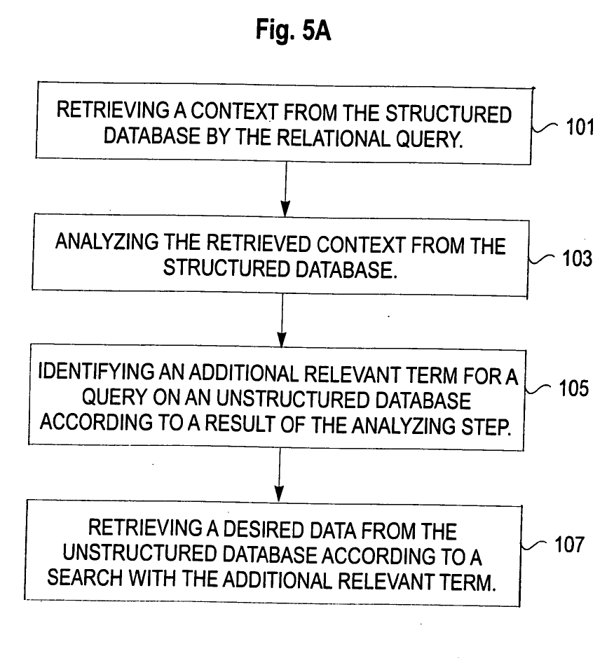

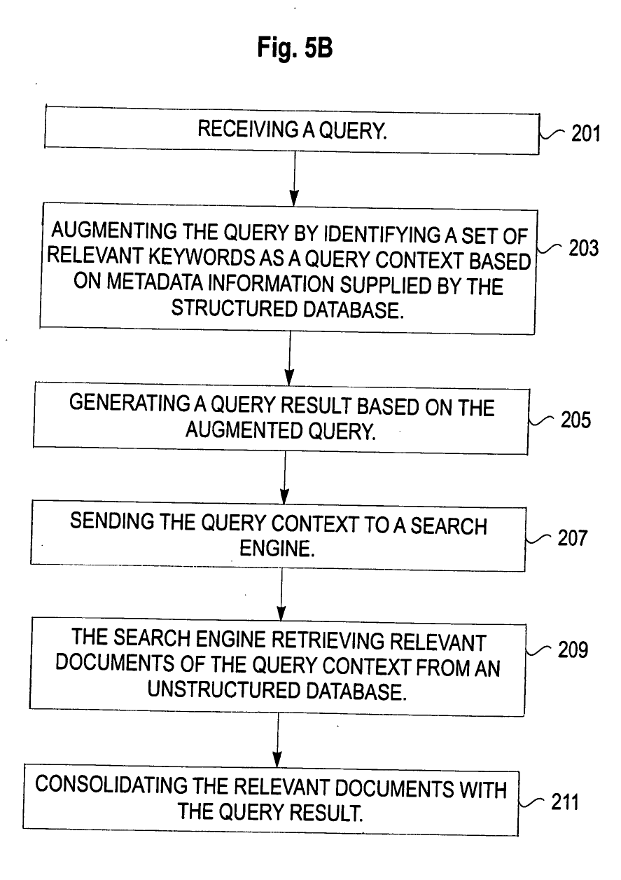

Other embodiments of the invention are illustrated in the flowcharts of FIGS. 5A and 5B, which refer to components described in FIGS. 1 through 4. FIG. 5A illustrates a method of retrieving relevant unstructured data based on a result of a relational query on a structured database 30, wherein the method comprises retrieving (101) a context from the structured database 30 by the relational query; analyzing (103) the retrieved context from the structured database 30; identifying (105) an additional relevant term for a query on an unstructured database 40 according to a result of the analyzing step (103); and retrieving (107) a desired data from the unstructured database 40 according to a search with the additional relevant term.

The step of analyzing (103) further comprises assigning weights to the context from the structured database 30 by the relational query; computing an overall weight for each term of the context; and selecting terms with high overall weights. The method further comprises characterizing the context of the relational query as a set of terms in a query result that the relational query is focused on and quantifying a query focus on the set of terms as a ratio of a rarity of a term in the structured database 30 to a rarity of the term in the query result. The method further comprises identifying terms most relevant to the relational query from all terms contained in the query result and identifying terms from the unstructured database 40 which are relevant to the relational query and excluded in the query result, wherein the step of identifying terms from the unstructured database 40 comprises augmenting the relational query with additional joins.

In the step of augmenting, the additional joins allow a search of a relevant immediate area of the relational query in the structured database 30 for additional relevant terms. Moreover, the method further comprises computing the context of the relational query, wherein the step of computing further comprises using available database statistics from the structured database 30; and eliminating multiple executions of the relational query in various stages of augmentation.

FIG. 5B illustrates a method of integrating relevant unstructured data based on a result of a relational query on a structured database 30, wherein the method comprises receiving (201) a query; augmenting (203) the query by identifying a set of relevant keywords as a query context based on metadata information supplied by the structured database; generating (205) a query result based on the augmented query; sending (207) the query context to a search engine 35; the search engine 35 retrieving (209) relevant documents of the query context from an unstructured database 40; and consolidating (211) the relevant documents with the query result.

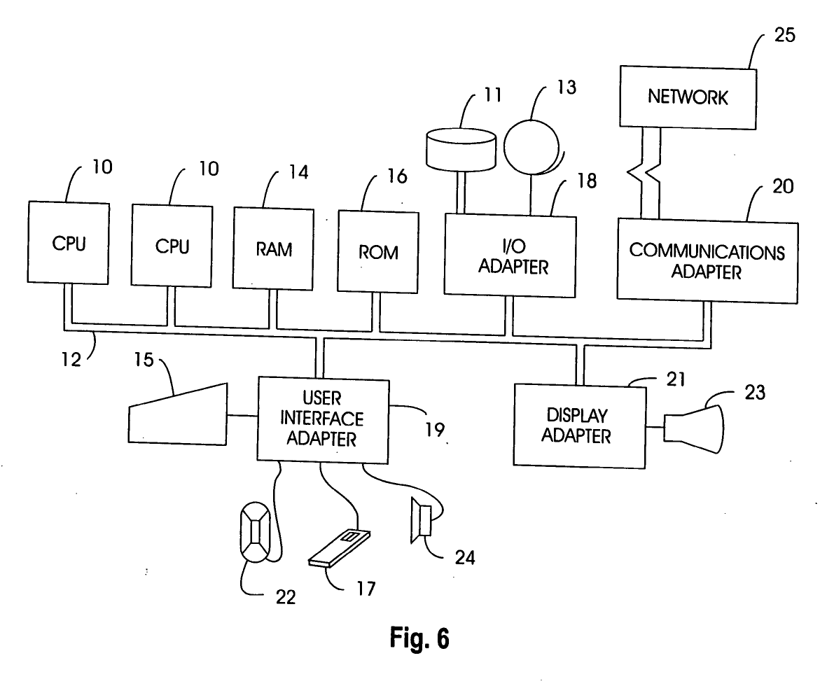

A representative hardware environment for practicing the embodiments of the invention is depicted in FIG. 6. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

A first aspect of the invention involves a novel technique of characterizing the context of a SQL query as the set of terms in the query result that the query is focused on. This, in turn, involves a novel way of quantifying the query's focus on the term as the ratio of the term's rarity in the underlying database to its rarity in the query result.

A second aspect of the invention involves a novel method for augmenting the query with carefully selected additional joins. These joins allow the system to explore the relevant immediate neighborhood of the input query in the underlying database for additional relevant terms. Accordingly, the embodiments of the invention provide a methodology that effectively identifies the most relevant joins to include in this modification.

A third aspect of the invention involves an efficient implementation approach towards computing the context of the input query. This involves making effective use of the available database statistics to identify the relevant additional joins to augment the query with. The methodology provided by the embodiments of the invention requires only a single execution of the query in various stages of augmentation; that of the final augmented query.

The embodiments of the invention take a different approach in dealing with structured and unstructured information integration compared with conventional approaches, which tend to provide a single point of access to the data, enabling the user, for instance, to access structured and unstructured data in a single query. As such, the embodiments of the invention provide a system that uses relevance information from one system (i.e., the structured database management system) to perform query expansion for another system (i.e., the unstructured content management system). Moreover, unlike conventional approaches towards integrating structured and unstructured data, the embodiments of the invention enable context-oriented information integration by automatically associating relevant unstructured data with the result of a relational (SQL) query on the structured data source; this involves (a) automatically computing the context of the SQL query, and (b) using this context to retrieve the unstructured data through a search engine.

As a result, finding the appropriate keywords is no longer the onus of the user because the system automatically derives them through statistical means. The user can, optionally, specify additional keywords and constraints as directives (e.g., if he/she is interested in patent document published after Mar. 1, 20004, he/she will be able to specify the additional keyword “Patent” and “date>‘03/01/04’”, which serves as a means for the user to specify additional information, if he/she has any).

Furthermore, the embodiments of the invention follow a non-intrusive approach, interfacing with the data sources using standard interfaces (JDBC®/ODBC (Java Database Connectivity/Open Database Connectivity interface with the RDBMS and keyword-based search engine interface with the text database). In particular, the embodiments of the invention do not require the maintenance of a common schema, thereby requiring minimal support from the user (or the DBA) as sources are modified.

Additionally, unlike conventional document-warehouse approaches, the embodiments of the invention handle the integration of text with data based on a full-text search, which is a more general approach. Furthermore, in contrast to other conventional approaches, the unstructured data according to the embodiments of the invention are not associated with a particular row in either a database table, or in the query result. Instead, the query result is considered as a whole rather than a sum of its constituent rows, and the unstructured data (text) is dynamically associated with the structured data (SQL query result) based on the latter's global context.

Finally, the embodiments of the invention generalize the conventional query expansion work in that the relevance information used to expand the query comes from a source (i.e., the structured data base management system) that is different from the source that is to be queried (i.e., the unstructured content management system).

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the invention has been described in terms of preferred embodiments, those skilled in the art will recognize that the embodiments of the invention can be practiced with modification within the spirit and scope of the appended claims.

What is claimed is:

1. A method of retrieving relevant unstructured data based on a result of a relational query on a structured database, said method comprising:
retrieving a context from said structured database by said relational query;
analyzing the retrieved context from said structured database;
identifying an additional relevant term for a query on an unstructured database according to a result of said analyzing; and
retrieving a desired data from said unstructured database according to a search with said additional relevant term.

2. The method of claim 1, wherein said analyzing further comprises:
assigning weights to said context from said structured database by said relational query;
computing an overall weight for each term of said context; and
selecting terms with high overall weights.

3. The method of claim 1, further comprising characterizing said context of said relational query as a set of terms in a query result that said relational query is focused on.

4. The method of claim 3, further comprising quantifying a query focus on said set of terms as a ratio of a rarity of a term in said structured database to a rarity of said term in said query result.

5. The method of claim 1, further comprising identifying terms most relevant to said relational query from all terms contained in said query result.

6. The method of claim 1, further comprising identifying terms from said unstructured database which are relevant to said relational query and excluded in said query result.

7. The method of claim 6, wherein said identifying comprises augmenting said relational query with additional joins.

8. The method of claim 7, wherein in said augmenting, said additional joins allow a search of a relevant immediate area of said relational query in said structured database for additional relevant terms.

9. The method of claim 1, further comprising computing said context of said relational query.

10. The method of claim 9, wherein said computing further comprises:
using available database statistics from said structured database; and
eliminating multiple executions of said relational query in various stages of augmentation.

11. A method of integrating relevant unstructured data based on a result of a relational query on a structured database, said method comprising:
receiving a query;
augmenting said query by identifying a set of relevant keywords as a query context based on metadata information supplied by said structured database;
generating a query result based on the augmented query;
sending said query context to a search engine;
said search engine retrieving relevant documents of said query context from an unstructured database; and
consolidating said relevant documents with said query result.

12. A program storage device readable by computer, tangibly embodying a program of instructions executable by said computer to perform a method of retrieving relevant unstructured data based on a result of a relational query on a structured database, said method comprising:
retrieving a context from said structured database by said relational query;
analyzing the retrieved context from said structured database;
identifying an additional relevant term for a query on an unstructured database according to a result of said analyzing; and
retrieving a desired data from said unstructured database according to a search with said additional relevant term.

13. The program storage device of claim 12, wherein said analyzing further comprises:
assigning weights to said context from said structured database by said relational query;
computing an overall weight for each term of said context; and
selecting terms with high overall weights.

14. The program storage device of claim 13, wherein said method further comprises characterizing said context of said relational query as a set of terms in a query result that said relational query is focused on.

15. The program storage device of claim 14, wherein said method further comprises quantifying a query focus on said set of terms as a ratio of a rarity of a term in said structured database to a rarity of said term in said query result.

16. The program storage device of claim 12, wherein said method further comprises identifying terms most relevant to said relational query from all terms contained in said query result.

17. The program storage device of claim 12, wherein said method further comprises identifying terms from said unstructured database which are relevant to said relational query and excluded in said query result.

18. The program storage device of claim 17, wherein said identifying comprises augmenting said relational query with additional joins.

19. The program storage device of claim 18, wherein in said augmenting, said additional joins allow a search of a relevant immediate area of said relational query in said structured database for additional relevant terms.

20. The program storage device of claim 12, wherein said method further comprises computing said context of said relational query.

21. The program storage device of claim 20, wherein said computing further comprises:
using available database statistics from said structured database; and
eliminating multiple executions of said relational query in various stages of augmentation.

22. A system for retrieving relevant unstructured data based on a result of a relational query on a structured database, said system comprising:
means for retrieving a context from said structured database by said relational query;
means for analyzing the retrieved context from said structured database;
means for identifying an additional relevant term for a query on an unstructured database according to a result of said analyzing; and
means for retrieving a desired data from said unstructured database according to a search with said additional relevant term.

23. The system of claim 22, further comprising:
means for assigning weights to said context from said structured database by said relational query;
means for computing an overall weight for each term of said context; and
means for selecting terms with high overall weights.

24. The system of claim 22, further comprising means for characterizing said context of said relational query as a set of terms in a query result that said relational query is focused on.

25. The system of claim 24, further comprising means for quantifying a query focus on said set of terms as a ratio of a rarity of a term in said structured database to a rarity of said term in said query result.

26. The system of claim 22, further comprising means for identifying terms most relevant to said relational query from all terms contained in said query result.

27. The system of claim 22, further comprising means for identifying terms from said unstructured database which are relevant to said relational query and excluded in said query result.

28. The system of claim 27, further comprising means for augmenting said relational query with additional joins.

29. The system of claim 28, further comprising means for searching a relevant immediate area of said relational query in said structured database for additional relevant terms.

30. The system of claim 22, further comprising means for computing said context of said relational query.

31. The system of claim 30, further comprising:
means for using available database statistics from said structured database; and
means for eliminating multiple executions of said relational query in various stages of augmentation.

32. A system for integrating relevant unstructured data based on a result of a relational query on a structured database, said system comprising:
a user interface;
a data broker adapted to manage an integration of structured and unstructured data, said data broker comprising:
a query handler adapted to receive a query from said user interface and to send a query result and relevant documents based on said query result to said user interface; and
a context handler adapted to receive a query from said query handler and to send said query result and a query context to said query handler;
a structured data management system adapted to receive an augmented query from said context handler;
an unstructured content management system; and
a search engine coupled to said unstructured content management system, wherein said search engine is adapted to receive said query context and directives from said query handler and to send relevant documents based on said query result to said query handler.

33. The system of claim 32, wherein said query comprises a structured query language (SQL) query.

34. The system of claim 32, wherein said query handler is adapted to receive directives from said user interface, wherein said directives comprise any of conditions on document metadata and additional keywords for said query.

35. The system of claim 32, wherein said structured data management system is adapted to send metadata to said context handler.

36. The system of claim 32, wherein said query context comprises terms that occur in greater proportion in said query result as compared to said structured data management system.

37. The system of claim 36, wherein said query context comprises keywords.

38. A system for integrating relevant unstructured data based on a result of a relational query on a structured database, said system comprising:
means for receiving a query;
means for augmenting said query by identifying a set of relevant keywords as a query context based on metadata information supplied by said structured database;
means for generating a query result based on the augmented query;
means for sending said query context to a search engine;
means for said search engine to retrieve relevant documents of said query context from an unstructured database; and
means for consolidating said relevant documents with said query result.
